(19) United States
(12) Patent Application Publication
(10) Pub. No.: US 2008/0113288 A1
(43) Pub. Date: May 15, 2008

(54) MANUFACTURING METHOD OF DEVELOPING AGENT AND COLORING AGENT DISPERSION FOR MANUFACTURING OF DEVELOPING AGENT

(75) Inventors: Masahiro Ikuta, Mishima (JP); Takashi Urabe, Sunto-gun (JP); Tsuyoshi Ito, Izunokuni (JP); Motonari Udo, Mishima (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/464,546

(22) Filed: Aug. 15, 2006

(51) Int. Cl. G03G 9/087; G03G 9/09

(52) U.S. Cl. 430/105; 430/137.14

(57) ABSTRACT

In a manufacturing method of a developing agent, by mixing a coloring agent fine particle with at least a surfactant, an aqueous solvent and an organic solvent, thereby dispersing the coloring agent fine particle in a solvent containing the surfactant, the aqueous solvent and the organic solvent, it becomes possible to obtain favorable coloring agent dispersibility and to improve the OHP transparency in the resulting developing agent.

### BACKGROUND OF THE INVENTION

1. Field of the Invention

The present invention relates to a manufacturing method of a developing agent which is used in image forming devices, for example, copiers and printers and to a coloring agent dispersion.

2. Description of the Related Art

In general, in an image forming device, an electrical latent image is first formed on an electrostatic latent image carrier such as a photoreceptor. This latent image is developed with a toner. The developed toner image is transferred onto a transfer material such as paper. An image is then formed through fixation by such as heating and pressurization or the like. A toner particle which is used for the image formation is mixed with a carrier particle and used as a two-component system developing agent. Alternatively, a magnetic toner particle or a non-magnetic toner particle is used as a single-component system developing agent in a single body.

In general, a toner particle is constituted of materials including a resin which becomes a binder, a coloring agent, a release agent such as waxes, and a charge inhibitor. In recent years, a polymerization method such as an emulsion polymerization method and a suspension polymerization method is employed as a formation method of a toner particle. According to the polymerization method, it can be expected to suppress a lowering of the developability and deterioration of the image quality by controlling the shape or surface composition of a toner particle through selection of a condition such as heating temperature.

A toner particle is formed by adding a dispersion of a coloring agent in a dispersion of a resin fine particle as prepared by such a polymerization method and going through steps including coagulation and fusion. At this time, the coloring agent dispersion is prepared by mixing a coloring agent fine particle in a solvent and dispersing the coloring agent fine particle by stirring by using an apparatus using a medium such as a sand mill, a ball mill, and a bead mill or a medium-free device such as a homogenizer, a clearmix, a filmics, and a nanomizer.

For example, in Japanese Patent No. 3107062, a coloring agent dispersion is prepared by mixing a pigment with a surfactant and ion exchanged water and dispersing the mixture by a homogenizer.

However, an air bubble is generated at the time of stirring by the surfactant to be mixed for making the dispersibility of the coloring agent fine particle favorable. And, the coloring agent fine particle as held in the air bubble cannot be dispersed and remains in a coagulated state. As a result, the coloring agent fine particle has non-uniform particle size distribution containing a coagulated particle having a large particle size. And, when used as a developing agent, there is involved a problem that favorable OHP transparency cannot be obtained.

### SUMMARY OF THE INVENTION

An object of the invention is to provide a manufacturing method of a developing agent a coloring agent dispersion for manufacturing of a developing agent from which favorable dispersibility of a coloring agent fine particle can be obtained in preparing a toner particle by a polymerization method and.

According to one embodiment of the invention, there is provided a manufacturing method of a developing agent including mixing a coloring agent fine particle with at least a surfactant, an aqueous solvent and an organic solvent, thereby dispersing the coloring agent fine particle in a solvent containing the surfactant, the aqueous solvent and the organic solvent.

Also, according to another embodiment of the invention, there is provided a coloring agent dispersion for manufacturing of a developing agent containing a coloring agent fine particle, a surfactant, an aqueous solvent and an organic solvent.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

FIG. 1 is a flow chart of a manufacturing process of a developing agent in one embodiment of the invention.

FIG. 2 is a table showing the kind and addition amount of each of a pigment, a surfactant and an organic solvent of a coloring agent dispersion, an average particle size and a CV value of a coloring agent fine particle, and an evaluation result of the OHP transparency of a toner particle using this coloring agent fine particle in the Examples and Comparative Examples of the invention.

### DETAILED DESCRIPTION OF THE EMBODIMENTS

The manufacturing method of a developing agent according to one aspect of the invention is characterized by mixing a coloring agent fine particle with at least a surfactant, an aqueous solvent and an organic solvent, thereby dispersing the coloring agent fine particle in a solvent containing the surfactant, the aqueous solvent and the organic solvent.

Also, the coloring agent dispersion for manufacturing of a developing agent according to another aspect of the invention is characterized by containing a coloring agent fine particle, a surfactant, an aqueous solvent and an organic solvent.

Here, as the coloring agent which is used for the coloring agent fine particle, various pigments such as carbon blacks, Chrome Yellow, Hansa Yellow, Quinoline Yellow, Benzidine Yellow, Threne Yellow, Vulcan Orange, Pyrazolone Orange, Permanent Orange GTR, Permanent Red, Watchung Red, Brilliant Carmine 3B, Brilliant Carmine 6B, Lithol Red, DuPont Oil Red, Pyrazolone Red, Rhodamine B Lake, Lake Red C, Rose Bengale, Aniline Blue, Ultramarine Blue, Calco Oil Blue, Methylene Blue Chloride, Phthalocyanine Blue, Phthalocyanine Green, and Malachite Green Oxalate; and known coloring agents such as acridine bases, xanthene bases, benzoquinone bases, azine bases, azo bases, azomethine bases, anthraquinone bases, thioindigo bases, indigo bases, thiazine bases, dioxazine bases, phthalocyanine bases, Aniline Black bases, tri-phenylmethane bases, diphenylmethane bases, polymethine bases, thiazine bases, thiazole bases, and xanthene bases can be used.

Such a coloring agent may be used singly or in combination of two or more kinds thereof. And, the content of the coloring agent is preferably from 0.5 to 80 wt % in the coloring agent dispersion. When the content of the coloring agent is less than 0.5 wt %, the concentration of solids in a coagulation step becomes thin. On the other hand, when it exceeds 80 wt %, a coarse particle is formed so that the desired particle size distribution is not obtained. The content of the coloring agent is more preferably from 2 to 50 wt %, and further preferably from 5 to 40 wt %.

Furthermore, examples of the surfactant which can be used include anionic surfactants, cationic surfactants, and nonionic surfactants. Examples of the anionic surfactant include sulfuric acid esters, sulfonic acid esters, and phosphoric esters. Examples of the cationic surfactant include amine salts and quaternary ammonium salts. Examples of the nonionic surfactant include polyethylene glycols, alkylphenol ethylene oxide adducts, and polyhydric alcohols. Such a surfactant may be used singly or in combination of two or more kinds thereof. And, the content of the coloring agent is preferably from 0.1 to 50 wt % in the coloring agent dispersion. When the content is less than 0.1 wt %, sufficient dispersion of the coloring agent cannot be obtained. On the other hand, when it exceeds 50 wt %, the coagulation becomes difficult due to the excessive surfactant. The content is more preferably from 0.5 to 30 wt %.

As the aqueous solvent for dispersing the coloring agent fine particle therein, purified water such as ion exchanged water, which is usually used as a dispersing medium, is used.

Though the organic solvent which is used for inhibiting the generation of an air bubble at the time of dispersing and controlling the particle size is not particularly limited, it is preferably an organic solvent provided with hydrophobicity and hydrophilicity. For example, when a fixed amount of an organic solvent is dissolved in octanol, the solution is added in two solvent phases of octanol and water and thoroughly mixed, the mixture is then separated into two phases and an organic solvent concentration in each of the phases is measured, an octanol/water partition coefficient Po/w represented by the following expression is preferably from −1 to 3. When the octanol/water partition coefficient Po/w is less than −1 or exceeds 3, a sufficient defoaming effect cannot be obtained.

Po/w=log₁₀Pow
Pow: Co/Cw
Co: Concentration of substance to be tested in 1-octanol layer (mole/L)
Cw: Concentration of substance to be tested in aqueous layer (mole/L)

Examples of such an organic solvent include alcohols such as methanol (Po/w=−0.82), ethanol (Po/w=−0.32), 1-propanol, 2-propanol (isopropyl alcohol: IPA) (Po/w=0.05), 2-methyl-2-propanol (Po/w=0.37), 1-butanol (Po/w=0.88), 2-butanol (Po/w=0.61), cyclohexanol, and 1-pentanol; ethers such as tetrahydrofuran and diethyl ether (Po/w=0.89); ketones such as acetone (Po/w=−0.24), ethyl methyl ketone (Po/w=0.29), and cyclohexanone (Po/w=0.81); esters such as ethyl acetate (Po/w=0.73), methyl acetate, and butyl acetate (Po/w=1.82); and toluene (Po/w=2.69). Such an organic solvent may be used singly or in combination of two or more kinds thereof.

For the purposes of inhibiting the generation of an air bubble as derived from the surfactant and dispersing the coloring agent particle without being held in an air bubble in order to make the particle size distribution sharp, the addition amount of such an organic solvent is preferably from 0.01 to 30 wt %. When the addition amount of the organic solvent is less than 0.01, an effect for inhibiting the generation of an air bubble cannot be sufficiently obtained, and it becomes difficult to prepare a uniform coloring agent dispersion. On the other hand, when it exceeds 30 wt %, since the organic solvent lowers the dispersing stability of the dispersion, coagulation is generated. The addition amount of the organic solvent is more preferably from 0.1 to 25 wt %.

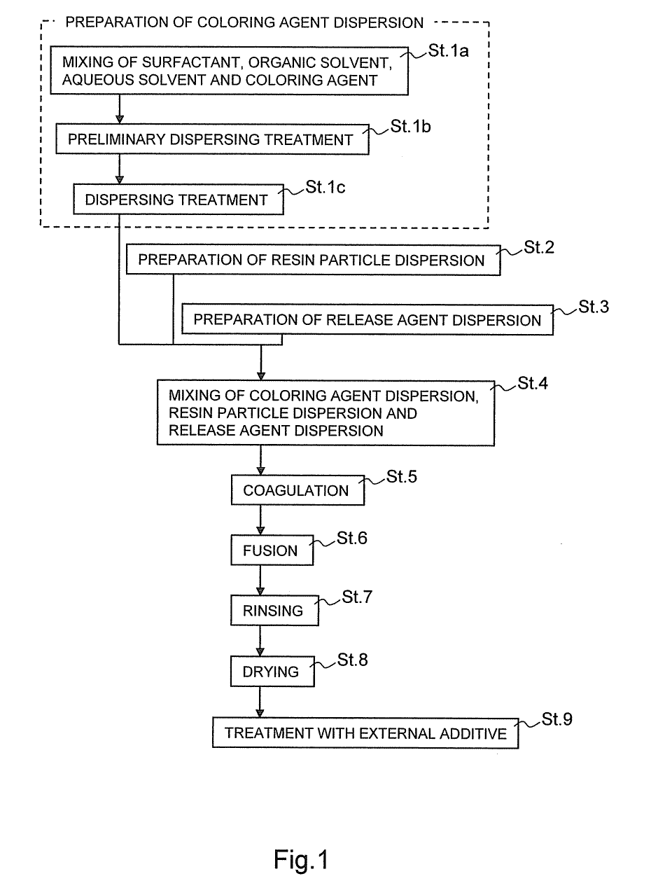

And, a coloring agent dispersion is prepared by using these coloring agent fine particle, surfactant, aqueous solvent and organic solvent. First of all, as shown in a flow chart of FIG. 1, a coloring agent fine particle, a surfactant, an aqueous solvent and an organic solvent are mixed (Step 1a). At this time, when the coloring agent fine particle is first mixed with the organic solvent, the coloring agent fine particle is coagulated. Accordingly, it is necessary that at least the coloring agent fine particle and the aqueous solvent are mixed, followed by mixing with the organic solvent, or that the organic solvent is mixed with at least the aqueous solvent, followed by mixing with the coloring agent fine particle.

After mixing these materials, the coloring agent fine particle is dispersed in an aqueous solvent by a usual mechanical dispersing method to prepare a coloring agent dispersion (Step 2). Examples of the mechanical dispersing method include measures using a medium such as a sand mill, a ball mill, and a bead mill; and medium-free measures such as a homogenizer, a clearmix, a filmics, and a nanomizer. These measures are properly selected. For example, as the need arises, after preliminary dispersing by a homogenizer (Step 1b), an atomization treatment is further carried out by a nanomizer (Step 1c).

A resin dispersion is separately prepared (Step 2). Examples of a resin which can be used as the resin dispersion include styrene based resins such as polystyrenes, styrene/butadiene copolymers, and styrene/acrylic copolymers; ethylene based resins such as polyethylene, polyethylene/vinyl acetate copolymers, and polyethylene/vinyl alcohol copolymers; polyester resins; acrylic resins; phenol based resins, epoxy based resins; allyl phthalate based resins; polyamide based resins; and maleic acid based resins. Such a resin is preferably formed by a polymerization method, for example, an emulsion polymerization method and may be used singly or in combination of two or more kinds thereof.

Furthermore, in order to bring release properties to the toner particle, in the case of containing a release agent such as waxes, a release agent dispersion is separately prepared (Step 3).

The thus prepared coloring agent dispersion, resin particle dispersion and release agent dispersion are mixed (Step 4). Then, by heating and stirring the mixed solution, the coloring agent fine particle, the resin fine particle and the release agent fine particle are coagulated to form a coagulated particle (Step 5). This coagulated particle is fused by heating and holding to form a fused particle (Step 6). The formed fused particle is repeatedly rinsed and filtered (Step 7) and then dried (Step 8) to form a toner particle. In addition, as the need arises, for the purpose of improving the fluidity, developability, charge properties and cleaning properties, an external agent such as inorganic fine particles, for example, silica and titanium oxide is added to this toner particle (Step 9). In addition, as the need arises, the resulting toner particle is mixed with a carrier to obtain a developing agent.

The invention will be specifically described below with reference to the following Examples. Incidentally, in the Examples and Comparative Examples, a laser diffraction type particle size distribution analyzer SLAD-7000 as manufactured by Shimadzu Corporation was used for the measurement of volume average particle size (particle size distribution). Furthermore, GPC (gel permeation chromatography) was employed for the measurement of molecular weight of a resin; and Waters Alliance 2695 was used as an analyzer main body and Waters 2414 was used as a detector. And, a sample was dissolved in tetrahydrofuran (THF); a soluble matter was measured by GPC; and a calibration curve of the molecular weight was prepared on a polystyrene basis by using a polystyrene standard particle. Furthermore, the OHP transparency was measured by using a spectrophotometer UV-3101PC (manufactured by Shimadzu Corporation) while setting up the measurement wavelength at 480 nm for cyan, 680 nm for magenta and 580 nm for yellow, respectively depending upon the coloring agent.

### EXAMPLE 1

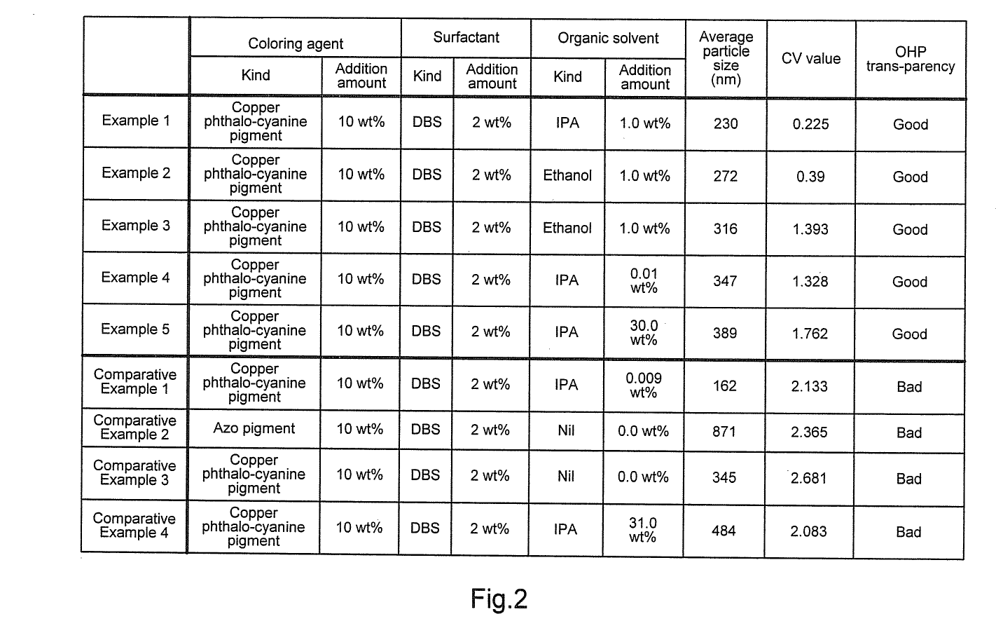

As shown in FIG. 2, 50 g (10 wt %) of copper phthalo-cyanine pigment (manufactured by Dainichiseika Color & Chemicals Mfg. Co., Ltd.) as a coloring agent fine particle, 10 g (2 wt %) of an anionic surfactant as a surfactant, 5 g (1.0 wt %) of isopropyl alcohol (IPA) as an organic solvent, and 425 g of ion exchanged water as an aqueous solvent were mixed such that only the coloring agent fine particle and the organic solvent were not mixed in advance, and the mixture was preliminarily dispersed by using a homogenizer (manufactured by IKA). The dispersion was then further dispersed by a nanomizer (manufactured by Yoshida Kikai Co., Ltd.) to prepare a dispersion of the coloring agent fine particle having a volume average particle size of 230 nm. As shown in FIG. 2, in such a coloring agent fine particle, a CV value as determined by (standard deviation of particle size distribution)/(volume average particle size) (values of not more than 1.8 are favorable) is 0.225; and it is understood that the residence of a coloring agent fine particle having a large particle size is suppressed because the generation of an air bubble is inhibited and the coloring agent fine particle is uniformly dispersed without hindering the dispersing due to an air bubble.

### (Preparation of Resin Fine Particle Dispersion)

1.8 g of a nonionic surfactant (manufactured by Sanyo Chemical Industries, Ltd.) and 3 g of an anionic surfactant (manufactured by Dai-ichi Seiyaku Co., Ltd.) were dissolved in 811.2 g of ion exchanged water to prepare a solvent. Separately, 300 g of styrene, 36.0 g of butyl acrylate, 4.5 g of acrylic acid and 13.5 g of dodecanethiol were mixed; the mixture was dispersed and emulsified in the solvent; and after sealing with nitrogen, the temperature of the solvent was raised to 75° C. Then, 20 g of a 10% ammonium persulfate solution was added and stirred at 75° C. for 4 hours, to which was then added 10 g of a 10% ammonium persulfate solution. In addition, the mixture was subjected to emulsion polymerization at 75° C. for 7 hours, thereby forming a latex having a resin fine particle dispersed therein. The resulting resin fine particle had a volume average particle size of 100 nm and a glass transition point Tg of 60° C. and had an average molecular weight Mw as measured by GPC of 37,540.

### (Preparation of Release Agent Dispersion)

100 g of a paraffin wax (melting point: 85° C., manufactured by Toakasei Co., Ltd.), 10 g of an anionic surfactant (manufactured by Kao Corporation) and 390 g of ion exchanged water were mixed and dispersed while heating at about 90° C. by using a homogenizer (manufactured by IKA). Thereafter, a dispersion of a release agent fine particle having a volume average particle size of 102 nm was prepared by using a wet type high-pressure emulsification machine (manufactured by IKA).

### (Formation of Coagulated Particle)

56 g of the coloring agent dispersion, 313 g of the resin fine particle dispersion (latex) and 120 g of the release agent dispersion as prepared, respectively were uniformly dispersed by using a homogenizer (manufactured by IKA) , and the dispersion was held at 50° C. for one hour while gently stirring, thereby forming a coagulated particle having a volume average particle size of 5.0 μm.

### (Formation of Fused Particle)

The dispersion having a coagulated particle formed therein was heated at 95° C. and holding for 5 hours, thereby forming a fused particle.

### (Formation of Toner Particle)

After repeating steps of rinsing with ion exchanged water the formed fused particle and filtering, the moisture of the particle was thoroughly removed by filtration and dried for 10 hours by a vacuum dryer (manufactured by Yamato Scientific Co., Ltd.) to form a dried particle (toner particle) having an average particle size of 5.0 μm. Then, 3 wt % of silica (manufactured by Nippon Aerosil Co., Ltd.) and 0.5 wt % of titanium oxide (manufactured by Ishihara Sangyo Kaisha, Ltd.) were externally added as external additives based on 100 wt % of this dried particle by using a Henschel mixer (manufactured by Mitsui Mining Company, Limited), thereby forming a toner particle.

### (Evaluation of Toner Particle)

Using the formed toner particle, development was carried out on OHP in a prescribed density by a modified machine of a full color copier FC-22 manufactured by Toshiba Tec Corporation, thereby evaluating the OHP transparency.

In the evaluation of OHP transparency, favorable transparency with a transmittance of 80% or more could be obtained. This is because since at the time of preparing the coloring agent dispersion, the generation of an air bubble was inhibited and the dispersing stability was improved by the addition of an organic solvent, the coloring agent fine particle was uniformly dispersed without hindering the dispersing due to an air bubble and influences against the transparency due to a coloring agent fine particle having a large particle size were suppressed.

### EXAMPLE 2

A dispersion of a coloring agent fine particle was prepared in the same manner as in Example 1, except for using 5 g (1.0 wt %) of ethanol as the organic solvent in place of 5 g of isopropyl alcohol (IPA) as shown in FIG. 2, thereby forming a coloring agent fine particle having a volume average particle size of 272 nm. In the formed coloring agent fine particle, a CV value was 0.39 as shown in FIG. 2, and the residence of a coloring agent fine particle having a large particle size was suppressed likewise Example 1.

In addition, a toner particle was formed in the same manner as in Example 1. The formed toner particle was evaluated in the same manner as in Example 1. As a result, in the evaluation of OHP transparency, as shown in FIG. 2, favorable transparency with a transmittance of 80% or more could be obtained likewise Example 1.

### EXAMPLE 3

A dispersion of a coloring agent fine particle was prepared in the same manner as in Example 1, except for using 5 g (1.0 wt %) of methanol as the organic solvent in place of 5 g of isopropyl alcohol as shown in FIG. 2, thereby forming a coloring agent fine particle having a volume average particle size of 316 nm. In the formed coloring agent fine particle, a CV value was 1.393 as shown in FIG. 2, and the residence of a coloring agent fine particle having a large particle size was suppressed likewise Example 1.

In addition, a toner particle was formed in the same manner as in Example 1. The formed toner particle was evaluated in the same manner as in Example 1. As a result, in the evaluation of OHP transparency, as shown in FIG. 2, favorable transparency with a transmittance of 80% or more could be obtained likewise Example 1.

### EXAMPLE 4

A dispersion of a coloring agent fine particle was prepared in the same manner as in Example 1, except for using 0.05 g (0.01 wt %) of isopropyl alcohol as the organic solvent as shown in FIG. 2, thereby forming a coloring agent fine particle having a volume average particle size of 347 nm. In the formed coloring agent fine particle, a CV value was 1.328 as shown in FIG. 2, and the residence of a coloring agent fine particle having a large particle size was suppressed likewise Example 1.

In addition, a toner particle was formed in the same manner as in Example 1. The formed toner particle was evaluated in the same manner as in Example 1. As a result, in the evaluation of OHP transparency, as shown in FIG. 2, favorable transparency with a transmittance of 80% or more could be obtained likewise Example 1.

### EXAMPLE 5

A dispersion of a coloring agent fine particle was prepared in the same manner as in Example 1, except for using 150 g (30 wt %) of isopropyl alcohol as the organic solvent as shown in FIG. 2, thereby forming a coloring agent fine particle having a volume average particle size of 389 nm. In the formed coloring agent fine particle, a CV value was 1.762 as shown in FIG. 2, and the residence of a coloring agent fine particle having a large particle size was suppressed likewise Example 1.

In addition, a toner particle was formed in the same manner as in Example 1. The formed toner particle was evaluated in the same manner as in Example 1. As a result, in the evaluation of OHP transparency, as shown in FIG. 2, favorable transparency with a transmittance of 80% or more could be obtained likewise Example 1.

### COMPARATIVE EXAMPLE 1

A dispersion of a coloring agent fine particle was prepared in the same manner as in Example 1, except for using 0.045 g (0.009 wt %) of isopropyl alcohol as the organic solvent as shown in FIG. 2, thereby forming a coloring agent fine particle having a volume average particle size of 162 nm. In the formed coloring agent fine particle, a CV value was 2.133 as shown in FIG. 2 so that it is understood that broadening of the particle size distribution is large.

In addition, a toner particle was formed in the same manner as in Example 1. The formed toner particle was evaluated in the same manner as in Example 1. As a result, in the evaluation of OHP transparency, as shown in FIG. 2, the transmittance was less than 80%, and favorable transparency could not be obtained.

### COMPARATIVE EXAMPLE 2

A dispersion of a coloring agent fine particle was prepared in the same manner as in Example 1, except for using 50 g (10 wt %) of an azo pigment (manufactured by Clariant) as the coloring agent in place of 50 g of the copper phthalocyanine pigment (manufactured by Dainichiseika Color & Chemicals Mfg. Co., Ltd.) and not adding the organic solvent as shown in FIG. 2, thereby forming a coloring agent fine particle having a volume average particle size of 871 nm. In the formed coloring agent fine particle, a CV value was 2.365 as shown in FIG. 2 so that it is understood that broadening of the particle size distribution is large.

In addition, a toner particle was formed in the same manner as in Example 1. The formed toner particle was evaluated in the same manner as in Example 1. As a result, in the evaluation of OHP transparency, as shown in FIG. 2, the transmittance was less than 80%, and favorable transparency could not be obtained.

### COMPARATIVE EXAMPLE 3

A dispersion of a coloring agent fine particle was prepared in the same manner as in Example 1, except for not adding the organic solvent as shown in FIG. 2, thereby forming a coloring agent fine particle having a volume average particle size of 345 nm. In the formed coloring agent fine particle, a CV value was 2.681 as shown in FIG. 2 so that it is understood that broadening of the particle size distribution is large.

In addition, a toner particle was formed in the same manner as in Example 1. The formed toner particle was evaluated in the same manner as in Example 1. As a result, in the evaluation of OHP transparency, as shown in FIG. 2, the transmittance was less than 80%, and favorable transparency could not be obtained.

### COMPARATIVE EXAMPLE 4

A dispersion of a coloring agent fine particle was prepared in the same manner as in Example 1, except for using 155 g (31.0 wt %) of isopropyl alcohol as the organic solvent as shown in FIG. 2, thereby forming a coloring agent fine particle having a volume average particle size of 484 nm. In the formed coloring agent fine particle, a CV value was 2.083 as shown in FIG. 2 so that it is understood that broadening of the particle size distribution is large.

In addition, a toner particle was formed in the same manner as in Example 1. The formed toner particle was evaluated in the same manner as in Example 1. As a result, in the evaluation of OHP transparency, as shown in FIG. 2, the transmittance was less than 80%, and favorable transparency could not be obtained.

As shown in these Examples and Comparative Examples, it is understood that the CV value varies depending upon the addition of an organic solvent and its addition amount, thereby affecting the transmittance in the evaluation of OHP transparency.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A manufacturing method of a developing agent comprising:
mixing a coloring agent fine particle with at least a surfactant, an aqueous solvent and an organic solvent;
dispersing the coloring agent fine particle in a solvent containing the surfactant, the aqueous solvent and the organic solvent.

2. The manufacturing method of a developing agent according to claim 1, wherein after mixing at least the coloring agent fine particle and the aqueous solvent, the organic solvent is mixed.

3. The manufacturing method of a developing agent according to claim 1, wherein after mixing the organic solvent with at least the aqueous solvent, the coloring agent fine particle is mixed.

4. The manufacturing method of a developing agent according to claim 1, wherein an amount of the organic solvent is from 0.01 to 30 wt % on a basis of the dispersion.

5. The manufacturing method of a developing agent according to claim 1, wherein the organic solvent has an octanol/water partition coefficient of from −1 to 3.

6. The manufacturing method of a developing agent according to claim 1, wherein the coloring agent fine particle after dispersing has a volume average particle size of not more than 500 nm.

7. The manufacturing method of a developing agent according to claim 1, wherein the coloring agent fine particle after dispersing has a CV value of not more than 1.8.

8. The manufacturing method of a developing agent according to claim 1, wherein prepared coloring agent dispersion is mixed with a resin particle dispersion.

9. The manufacturing method of a developing agent according to claim 8, wherein the resin particle is prepared by a polymerization method.

10. The manufacturing method of a developing agent according to claim 8, further comprising mixing with a release agent.

11. The manufacturing method of a developing agent according to claim 8, further comprising the coloring agent fine particle and the resin are coagulated, fused, rinsed and dried to form a toner particle.

12. The manufacturing method of a developing agent according to claim 11, further comprising an external additive is added to the toner particle.

13. A coloring agent dispersion for manufacturing of a developing agent comprising;
a coloring agent fine particle;
a surfactant;
an aqueous solvent and an organic solvent.

14. The coloring agent dispersion according to claim 13, wherein an amount of the organic solvent is from 0.01 to 30 wt % on a basis of the coloring agent dispersion.

15. The coloring agent dispersion according to claim 13, wherein the organic solvent has an octanol/water partition coefficient of from −1 to 3.

16. The coloring agent dispersion according to claim 13, wherein the coloring agent fine particle after dispersing has a volume average particle size of not more than 500 nm.

17. The coloring agent dispersion according to claim 13, wherein the coloring agent fine particle has a CV value of not more than 1.8.
